(19) United States
(12) Patent Application Publication
(10) Pub. No.: US 2019/0187475 A1
(43) Pub. Date: Jun. 20, 2019

(54) MULTI-IMAGE HEAD UP DISPLAY (HUD)

(71) Applicant: Panasonic Automotive Systems Company of America, Division of Panasonic Corporation of North America, Peachtree City, GA (US)

(72) Inventors: EDO OMANOVIC, MADISON HEIGHTS, MI (US); PATRICK O'CONNELL, NOVI, MI (US)

(73) Assignee: Panasonic Automotive Systems Company of America, Division of Panasonic Corporation of North America

(21) Appl. No.: 16/221,968

(22) Filed: Dec. 17, 2018

Related U.S. Application Data
(60) Provisional application No. 62/607,524, filed on Dec. 19, 2017.

(51) Int. Cl. G02B 27/01; G08G 1/16

(52) U.S. Cl. CPC G02B 27/0172; G02B 27/0101; G08G 1/166; G08G 1/165; G02B 27/0149

(57) ABSTRACT

An optical arrangement for a motor vehicle has a head up display light field emitter that emits a light field including a plurality of images simultaneously. At least one mirror is positioned to reflect the light field such that the light field is again reflected by a windshield of the vehicle, and such that the light field is visible to a driver of the vehicle as a plurality of virtual images that are each at a different respective distance from the driver. Each of the virtual images corresponds to one of the images in the light field.

### CROSS-REFERENCED TO RELATED APPLICATIONS

This application claims benefit of U.S. Provisional Application No. 62/607,524 filed on Dec. 19, 2017, which the disclosure of which is hereby incorporated by reference in its entirety for all purposes.

### FIELD OF THE INVENTION

The disclosure relates to a head up display (HUD) system in a motor vehicle.

### BACKGROUND OF THE INVENTION

A head up display emits light that reflects from the front windshield to be seen by the driver. The light appears to come from a virtual image in front of the driver and in front of the windshield.

Conventional head up displays create the virtual image by first using a display to create an image. Next, the light from the image is reflected from one or more mirrors, and then the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

Various human machine interface (HMI) designs for virtual images of HUDs require further virtual image distances (VIDs), such as augmented reality (AR). However, currently all HUDs in production display their virtual images only at a single distance.

The present invention may provide a head up display arrangement in a motor vehicle which enables multiple virtual images to be displayed at different virtual image distances (VIDs). The inventive head up display arrangement may enable pertinent information such as speed to be displayed at a closer distance than AR features such as lane markings and navigation information. The arrangement may include a single display, and different areas of the display may be displayed at different distances to the driver.

In one embodiment, the invention comprises a head up display arrangement for a motor vehicle, having a head up display light field emitter that emits a light field simultaneously including a plurality of images. At least one mirror is positioned to reflect the light field such that the light field is again reflected by a windshield of the vehicle, and such that the light field is visible to a driver of the vehicle as a plurality of virtual images that are each at a different respective distance from the driver. Each of the virtual images corresponds to one of the images in the light field.

In another embodiment, the invention comprises an optical method for a motor vehicle, including emitting a light field that simultaneously includes a plurality of images. The light field is reflected such that the light field is again reflected by a windshield of the vehicle, and such that the light field is visible to a driver of the vehicle as a plurality of virtual images that are each at a different respective distance from the driver. Each of the virtual images corresponds to one of the images in the light field.

In yet another embodiment, the invention comprises an optical arrangement for a motor vehicle, including a head up display light field emitter that emits a light field that simultaneously includes a plurality of images. A plurality of mirrors are each positioned to reflect a respective image of the light field such that the images are again reflected by a windshield of the vehicle, and such that the images are visible to a driver of the vehicle as a plurality of virtual images that are each at a different respective distance from the driver. Each of the virtual images corresponds to one of the images in the light field.

### BRIEF DESCRIPTION OF THE DRAWINGS

A better understanding of the present invention will be had upon reference to the following description in conjunction with the accompanying drawings.

FIG. 1 is a schematic view of one example embodiment of a multi-image HUD arrangement of the present invention.

FIG. 2 is a flow chart of one embodiment of an optical method of the present invention for a motor vehicle.

### DETAILED DESCRIPTION OF THE PREFERRED EMBODIMENTS

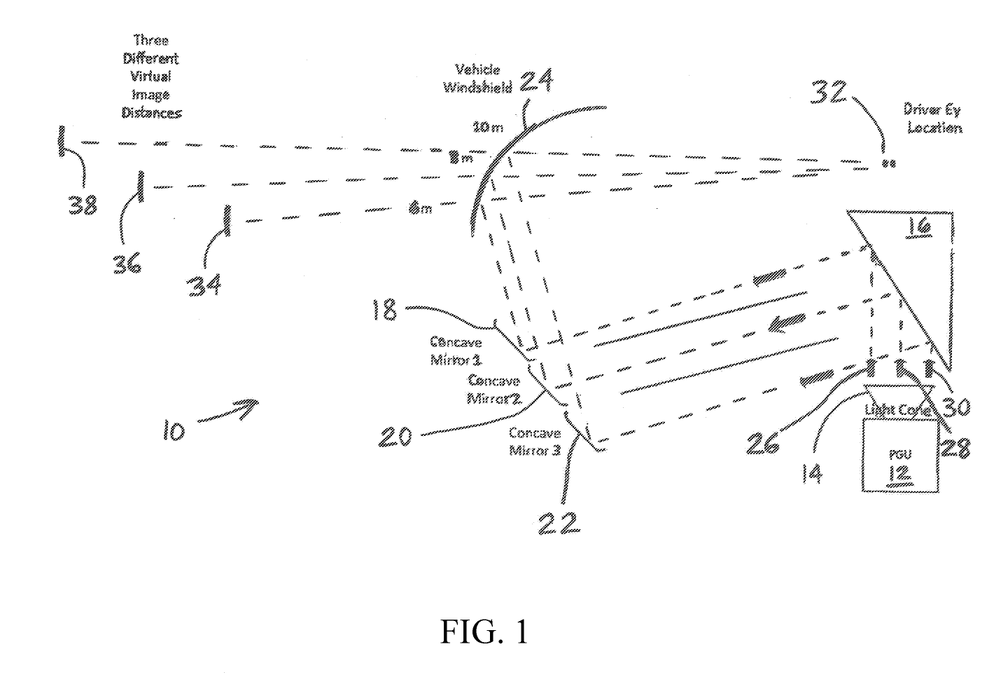

FIG. 1 illustrates one example embodiment of a multi-image HUD arrangement 10 of the present invention, including a picture generation unit (PGU) 12, a light cone 14, a fold mirror 16, concave mirrors 18, 20, 22, and a windshield 24.

During use, PGU 12 and light cone 14 emit a light field that includes three separate simultaneous images 26, 28, 30 which are reflected off of mirrors 18, 20, 22, respectively, and off of windshield 24 such that the light field is visible to eyes 32 of a human driver as virtual images 34, 36, 38 corresponding to images 26, 28, 30, respectively. That is, images 26, 28, 30 may be present at a same point in time in the light field such that each of virtual images 34, 36, 38 is available to be seen by eyes 32 substantially at that same point in time. Because images 26, 28, 30 may impinge upon windshield 24 at different angles, because eyes 32 view the areas of impingement at different angles, and/or because windshield 24 has different curvatures at the areas of impingement, virtual images 34, 36, 38 may appear to be disposed at different distances in front of windshield 24, such as 6 meters, 8 meters, and 10 meters, respectively.

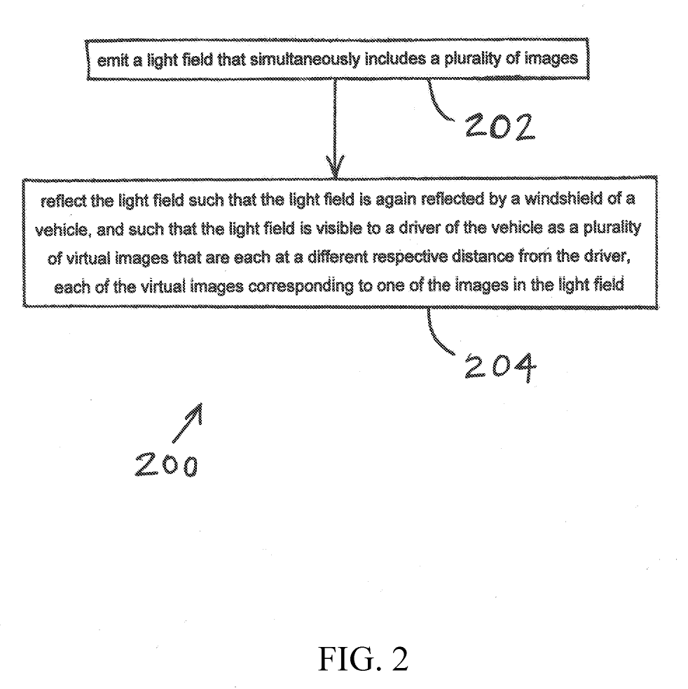

FIG. 2 illustrates one embodiment of an optical method 200 of the present invention for a motor vehicle. In a first step 202, a light field is emitted that simultaneously includes a plurality of images. For example, PGU 12 and light cone 14 emit a light field that includes three separate simultaneous images 26, 28, 30.

In a final step 204, the light field is reflected such that the light field is again reflected by a windshield of the vehicle, and such that the light field is visible to a driver of the vehicle as a plurality of virtual images that are each at a different respective distance from the driver, each of the virtual images corresponding to one of the images in the light field. For example, images 26, 28, 30 are reflected off of mirrors 18, 20, 22, respectively, and off of windshield 24 such that the light field is visible to eyes 32 of a human driver as virtual images 34, 36, 38 corresponding to images 26, 28, 30, respectively. Virtual images 34, 36, 38 may appear to be disposed at different distances in front of windshield 24, such as 6 meters, 8 meters, and 10 meters, respectively.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An optical arrangement for a motor vehicle, the arrangement comprising:
a head up display light field emitter configured to emit a light field including a plurality of images simultaneously; and
at least one mirror positioned to reflect the light field such that the light field is again reflected by a windshield of the vehicle, and such that the light field is visible to a driver of the vehicle as a plurality of virtual images that are each at a different respective distance from the driver, each of the virtual images corresponding to one of the images in the light field.

2. The optical arrangement of claim 1 wherein the light field emitter includes a picture generation unit.

3. The optical arrangement of claim 2 wherein the light field emitter includes a light cone.

4. The optical arrangement of claim 1 wherein the at least one mirror comprises a plurality of mirrors, each said mirror being positioned to reflect a respective said image of the light field.

5. The optical arrangement of claim 1 wherein the plurality of mirrors includes a plurality of first mirrors and a second mirror, each said first mirror being positioned to reflect a respective said image of the light field, the second mirror comprising a fold mirror.

6. The optical arrangement of claim 5 wherein the fold mirror is positioned to reflect the images of the light field onto the first mirrors.

7. The optical arrangement of claim 6 wherein the first mirrors comprise concave mirrors.

8. An optical method for a motor vehicle, the method comprising:
emitting a light field that simultaneously includes a plurality of images; and
reflecting the light field such that the light field is again reflected by a windshield of the vehicle, and such that the light field is visible to a driver of the vehicle as a plurality of virtual images that are each at a different respective distance from the driver, each of the virtual images corresponding to one of the images in the light field.

9. The optical method of claim 8 wherein the light field is emitted by a picture generation unit.

10. The optical method of claim 8 wherein the light field is emitted by a picture generation unit and a light cone.

11. The optical method of claim 8 wherein the light field is reflected by a plurality of mirrors, each said mirror reflecting a respective said image of the light field.

12. The optical method of claim 8 wherein the reflecting is at least partially performed by a plurality of mirrors including a plurality of first mirrors and a second mirror, each said first mirror reflecting a respective said image of the light field, the second mirror comprising a fold mirror.

13. The optical method of claim 12 wherein the fold mirror reflects the images of the light field onto the first mirrors.

14. The optical method of claim 13 wherein the first mirrors comprise concave mirrors.

15. An optical arrangement for a motor vehicle, the arrangement comprising:
a head up display light field emitter configured to emit a light field that includes a plurality of images simultaneously; and
a plurality of mirrors each positioned to reflect a respective said image of the light field such that the images are again reflected by a windshield of the vehicle, and such that the images are visible to a driver of the vehicle as a plurality of virtual images that are each at a different respective distance from the driver, each of the virtual images corresponding to one of the images in the light field.

16. The optical arrangement of claim 15 wherein the light field emitter includes a picture generation unit.

17. The optical arrangement of claim 16 wherein the light field emitter includes a light cone.

18. The optical arrangement of claim 15 wherein the plurality of mirrors includes a plurality of first mirrors and a second mirror, each said first mirror being positioned to reflect a respective said image of the light field, the second mirror comprising a fold mirror.

19. The optical arrangement of claim 18 wherein the fold mirror is positioned to reflect the images of the light field onto the first mirrors.

20. The optical arrangement of claim 19 wherein the first mirrors comprise concave mirrors.
